(19) United States
(12) Patent Application Publication
(10) Pub. No.: US 2004/0022529 A1
(43) Pub. Date: Feb. 5, 2004

(54) Heater

(76) Inventor: Leo Lamb, Liverpool (GB)

Correspondence Address: Charles N Quinn, Fox Rothschild O'Brien & Frankel, 10th Floor, 2000 Market Street, Philadelphia, PA, 19103, US

(21) Appl. No.: 10/344,438

(22) PCT Filed: Aug. 10, 2001
(86) PCT No.: PCT/GB01/03630

(30) Foreign Application Priority Data
Aug. 11, 2000 (GB) 0019655.0
Sep. 28, 2000 (GB) 0023768.5
Oct. 5, 2000 (GB) 0024345.1
Oct. 13, 2000 (GB) 0025131.4
Oct. 30, 2000 (GB) 0026515.7

(51) Int. Cl. H05B 3/78

(52) U.S. Cl. 392/465; 392/485

(57) ABSTRACT

A heater comprising a substantially vertical heatpipe in contact or fluid communication with at least one additional heatpipe that is extendable in a substantially horizontal direction therefrom, at least one of the heatpipes being at least partially evacuated and having an internal cavity for receiving a working fluid and at least one of the heatpipes being adapted to receive heat from an internal or external heat source.

### DESCRIPTION

The present invention relates to an improved heater, particularly but not exclusively in the form of a heated rail for drying articles.

Conventionally, buildings are heated by means of radiators that are provided at intervals throughout the building. A main hot water pipe is heated by a boiler and the heated water is then delivered via pipes to the individual radiators. The water flows into subsidiary pipes provided in the radiator which results in the radiator heating up and releasing heat to the surroundings by means of radiation, convection and conduction.

Such radiators may also be used for drying clothes and the like by placing the articles over or close to the radiator. Towel rails have also been formed wherein the water pipe is convoluted to form horizontal bars over which the articles to be dried or aired may be placed. However, the overall use of energy using these heaters is wasteful, requiring a great deal of energy to be expended in heating and maintaining the temperature of the water and pumping it around the building and then along convoluted pipes contained within each radiator. The pipes and radiators are also subject to the build up of pressure which, although rare, can result in a pipe bung.

Additionally, the radiators are bulky and expensive. The radiators are also difficult to move once installed in a particular location due to the main water pipes being provided with auxiliary pipework for the delivery of water to the radiator in the regions where radiators are to be located in a particular building. Thus, changing the positioning of a radiator would require substantial alterations to the pipework of the system.

It is an object of the present invention to provide an improved heater that aims to overcome the abovementioned drawbacks.

Accordingly, the present invention provides a heater comprising a substantially vertical heatpipe in contact or fluid communication with at least one additional heatpipe that is extendable in a substantially horizontal direction therefrom, at least one of the heatpipes being at least partially evacuated and having an interior cavity for receiving a working fluid and at least one of the heatpipes being adapted to receive heat from an internal or external heat source.

Preferably, the heater comprises at least one vertical heatpipe that is in contact or fluid communication with a plurality of secondary heatpipes extending substantially horizontally therefrom. Preferably, both the primary and secondary heatpipes are at least partially evacuated and contain a small amount of working fluid. The horizontal heatpipes may each extend in the same direction and be provided at spaced apart intervals to provide a series of rails for hanging articles, such as towels. Preferably, the lowest rail is placed in contact with the heat source.

Alternatively, the primary heatpipe may have multiple secondary heatpipes extending therefrom in different directions, for example forming a star radiating outwardly from the central primary heatpipe. Preferably, in use, the secondary heatpipes extend substantially perpendicularly from the primary heatpipe. Preferably, the primary heatpipe is enclosed within a casing. Preferably, one or more brackets are provided around the primary heatpipe, each bracket having at least one extension for receiving a secondary heatpipe. The bracket may be rotatable about the primary heatpipe. The secondary heatpipe may be fixedly secured to the bracket or may be detachable therefrom. The extension of the bracket may be hinged to enable the secondary heatpipe to be folded against the casing when not in use.

More preferably, the bracket and extension are dimensioned to be substantially the same size as the part that fits therein, i.e., the vertical or horizontal heatpipes respectively. The bracket and/or extension may be provided with a slit or cut therethrough to enable that section to be fitted over or receive the respective component part. Suitable fastening means, such as Allen screws and keys, may be used across said slit or cut to clamp the components within the bracket and extension. Preferably, the bracket is provided with a longitudinal slit along the length thereof The extension is preferably provided with at least one, more preferably two, slits at right angles to the slit in the bracket.

Preferably, the bracket is formed by means of a cast moulding.

The heat source may be, for example, hot water that is delivered along a conduit, such as a conventional hot water pipe. The water may be heated by, for example, gas or electricity. In the embodiment where the horizontal heatpipes extend in the same direction, the lowermost heat pipe and the base of the vertical heatpipe are preferably placed in contact with the hot water pipe. Preferably, the lower edges of the heatpipes that contact the hot water pipe are provided with a concave profile to abut the convex profile of the water pipe. Alternatively, the heatpipe and hot water pipes may be surrounding by brackets that have flat edges to enable abutment of the respective pipes. Preferably, the brackets are adhered together. It is to be appreciated that the brackets and pipes should be made of a suitable heat conducting material, such as aluminium or steel.

Alternatively, the heat source may be electricity wherein the heatpipes are heated by means of an electric coil wound around some or all of the pipes or by a heating element disposed in one or more of the pipes.

The heater may be provided with an integral heat source which provides a separate means of heating the heater, thereby permitting the heater to be heated by either the integral heat source or take its heat from the external heat source. Where an integral heat source is provided, preferably it comprises an electric heating element which is disposed in at least one of the heat pipes. Preferably it is disposed in a vertical heat pipe. When an integral heat source is provided, the heater is not reliant on having one of the heat pipes adapted to receive heat from an external heat source.

Alternatively, the internal heat source may be provided by means of a heat transfer pipe extending up the interior of the primary heatpipe, the heat transfer pipe transporting a heat transfer medium, such as water. Preferably, the heat transfer pipe primary heatpipe being sealed at both ends but having an outlet port to transport the heat transfer medium away from the heater. In this embodiment, only the secondary heatpipes are self-contained units that may be partially evacuated. Again, any number of secondary heatpipes may extend from the primary heatpipe, the secondary heatpipes being fixedly or rotatably secured thereto.

Alternatively, the internal heat source may extend through one or more of the horizontal heatpipes. Preferably, a hot water pipe runs through the interior of the lowermost heatpipe, the heatpipe being a sealed, self-contained unit that is partially evacuated.

The heater of the present invention provides for a change in direction of heat transfer. Preferably, in use, the horizontal heatpipes slope slightly upwardly from the vertical heatpipe, for example +0.1 to 5° from the horizontal.

It is to be appreciated that all the evacuated heatpipes are sealed at their free ends to provide the self-contained unit which may be partially evacuated by means of, for example, a valve, provided in one or more the heatpipes.

The heater of the present invention may be provided with a cover to provide a conventional radiator. Preferably, the cover is removable.

Additionally, the heater may be provided with a buffer to disperse any kettling activity. Preferably, the buffer is in the form of a wire mesh, such as a stainless steel mesh, provided above or around the heat source.

In a preferred embodiment of the present invention, a heater is provided that has a vertical primary heatpipe having a series of spaced apart substantially horizontal heatpipes rotatably mounted thereto. The vertical heatpipe may be wall bracket attached to the wall and all the horizontal heapipes may be orientated to lie against the wall in a ladder-configuration. Preferably, a further stabilizing bar is provided parallel with the vertical heatpipe to receive the free ends of the horizontal heatpipes. Retaining means, such as clips, may be provided in the appropriate places on the stabilizing bar to receive and retain the horizontal heatpipes in the ladder-configuration. The horizontal heatpipes may be released from their retainers and rotated outwardly from the wall, as desired An external and/or internal heat source may be provided in contact or fluid communication with the vertical heatpipe and/or lowermost horizontal heatpipe.

For a better understanding of the present invention and to show more clearly how it may be carried into effect, reference will now be made by way of example only to the accompanying drawings in which:—

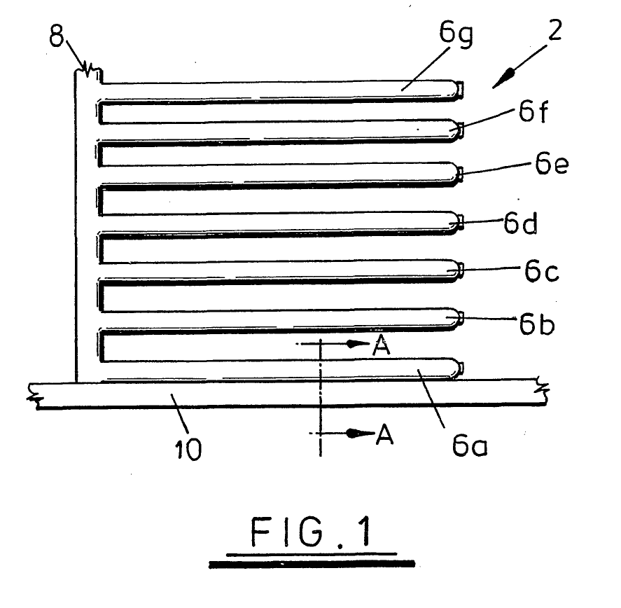

FIG. 1 is a front elevational view of a heater according to one aspect of the present invention;

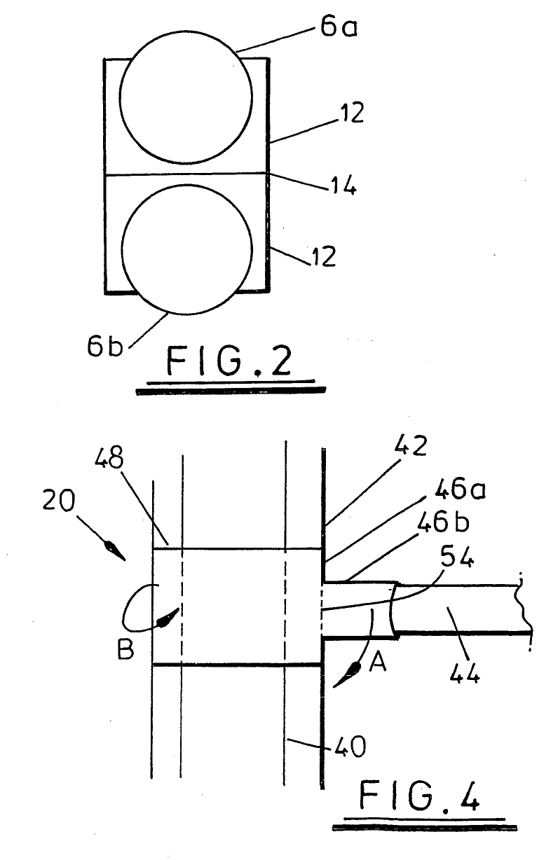

FIG. 2 is a cross-sectional view along line A-A of FIG. 1;

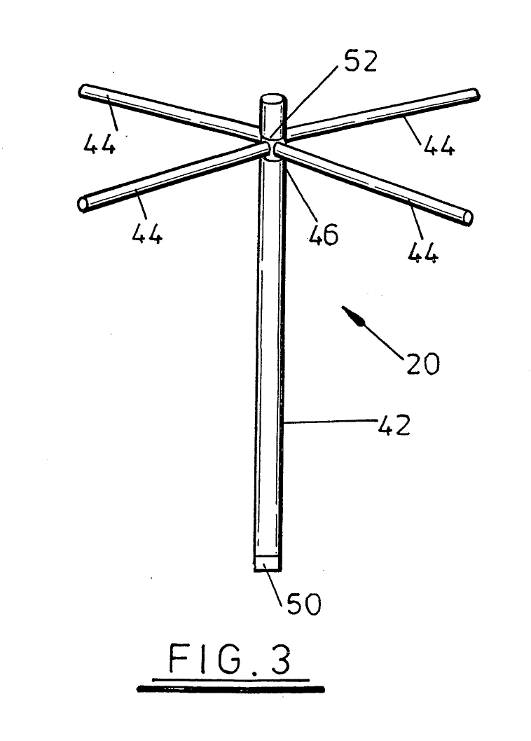

FIG. 3 is a perspective view of a heater according to another embodiment of the present invention;

FIG. 4 is a longitudinal sectional view of part of the heater shown in FIG. 3;

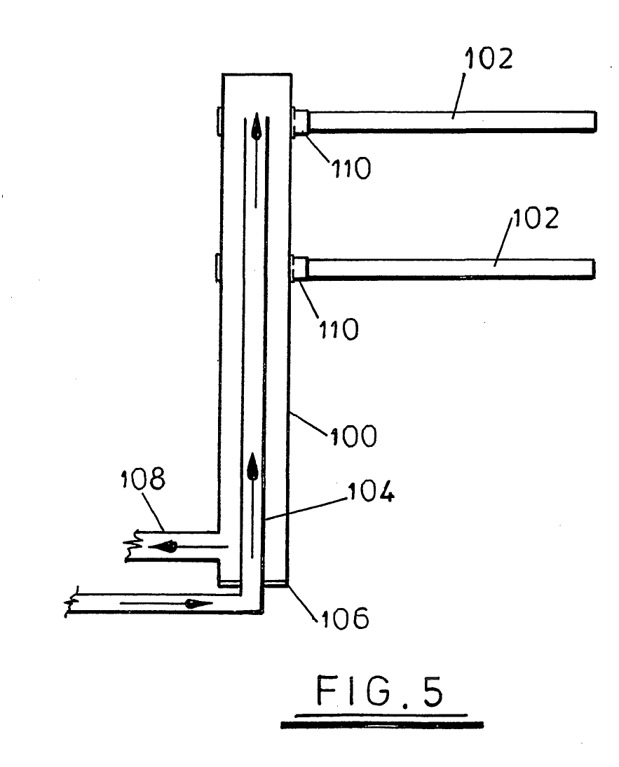

FIG. 5 is a longitudinal sectional view of a heater according to yet another embodiment of the present invention;

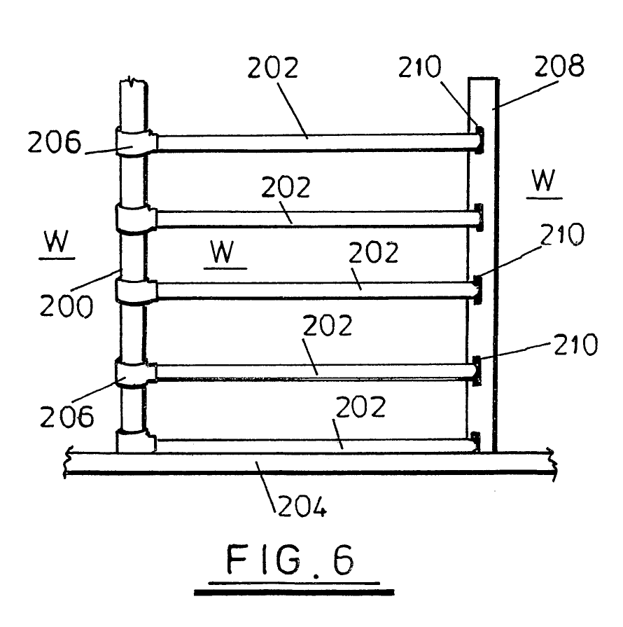

FIG. 6 is a front elevational view of a heater according to a further embodiment of the present invention, shown in one configuration; and

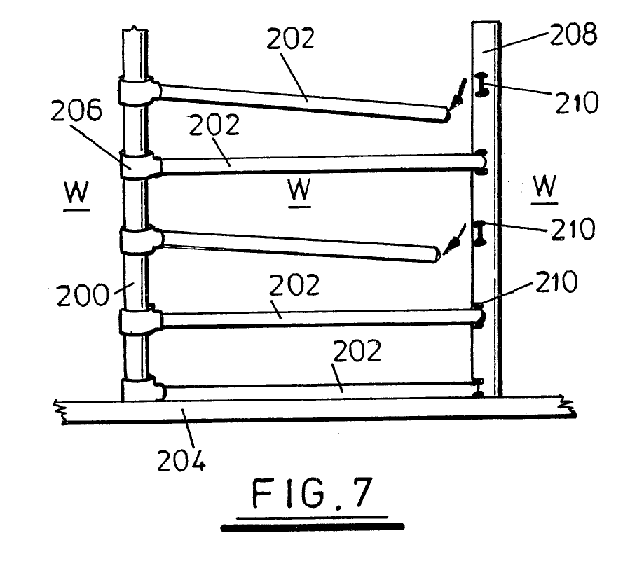

FIG. 7 is a front elevational view of the heater shown in FIG. 6 shown in an

Referring to FIG. 1 of the accompanying drawings, a heater 2 according to one embodiment of the present invention is illustrated. The heater comprises a vertical heatpipe 4 that is in fluid communication with a number of horizontal heatpipes, 6a, 6b, 6c, 6d, 6e, 6f and 6g, extending substantially perpendicularly therefrom The horizontal pipes slope very slightly upwards with distance from the vertical pipe, for example at a gradient of approximately +2° from the horizontal plane. Both the vertical and horizontal pipes are partially evacuated and contain a small amount of working fluid therein, such as water and are all blanked at their free ends to create a self-contained unit. One or more of the pipes are provided with a valve 8 to enable evacuation thereof and to allow the introduction of the working fluid The inner walls of the heatpipes should be protected against corrosive influence due to the presence of the working fluid.

The base of the vertical pipe 4 and the underside of the lowest horizontal pipe 6a are fixed in contact with a heat source, in the form of a pipe 10 transporting a heat conducting medium, such as water that has been heated, for example, by means of a gas boiler. The pipe is a conventional pipe comprised of a heat conducting material. FIG. 2 of the accompanying drawings illustrates one mechanism for attaching the lowest horizontal pipe to the heat source, albeit it is to be appreciated that other types of fixing may be used in the heater of the present invention. Both the hot water pipe 10 and the horizontal heatpipe 6a are partially surrounded by a conducting bracket 12 that has a flat edge 14. The respective flat edges of the brackets are sealed together using an adhesive that assists in allowing heat to be efficiently transferred from the hot water pipe to the heatpipe.

In this manner, the hot water pipe is able to heat up the entire length of the lowest horizontal pipe as well as the base of the vertical heatpipe 4, thereby heating up the working fluid in the heater 2 which evaporates below its normal boiling point due to the vacuum that exists inside the heatpipes. The reduced pressure inside the heater also allows the fluid to move rapidly therethrough and, as it does so, condenses to release its latent heat of condensation thereby transferring heat to the walls of the pipes and hence, the surrounding atmosphere. The fluid is re-circulated to provide a continuous source of heating to the area provided with the heater. The horizontal arms 6a-6g of the heater result in the heater being particularly suitable for drying and airing articles, such as towels without having to provide a convoluted pipe that requires a continuous flow of hot water to pumped therethrough.

The actual volume of fluid contained in the interior cavity of the heater will depend upon the particular dimensions of the unit. Similarly, the amount of vacuum that exists in the heater is important for efficient operation thereof The amount will depend upon the size of the pipes, the temperature required and the volume of working fluid and maybe obtained by the law of thermodynamics.

The heater according to the present invention enables heat to be transferred in the horizontal as well as the vertical direction through partially evacuated pipes. The lowest pipe is heated by the hot water pipe to cause evaporation of the working fluid therein. This flows back along the pipe due to the slight gradient and is re-evaporated by the heat that has been conducted up the vertical pipe. This process enables the heater to heat up very quickly and efficiently.

It is to be appreciated that the heater may be provided with an alternative heat source, such as electricity. In this embodiment, energy may be supplied via the mains electricity. This would enable the heater to be provided as a stand-alone unit whereby it could be positioned in any location providing it was possible to connect the heater to the mains supply. Alternatively, the lowermost horizontal heatpipe may be provided with an internal heat source. For example, a heat transfer pipe may extend through the lowest heatpipe. The heatpipe is self-contained, partially evacuated and provided with working fluid. The sealed heatpipe is entirely separate to the heat transfer pipe that extends therethrough and transmits a heat transfer medium, such as gas or water, to effect heating of the heatpipe.

A buffer, for example in the form of a wire mesh or gauze, may be provided on top or around the heat source, such as the electrical heating element, to allow vapour therethrough but dispersing and destroying molecules in the system thereby preventing any kettling activity occurring within the heater which is undesirable. The size of the gauze or mesh is dependent upon the actual size of the heater unit and the wattage of the heating element.

The unit may also be encased in a cover to provide a radiator. This cover may be detachable so that the heater could be used as a towel rail when required.

The heater has a number of advantages over those of the prior art. Firstly, the heater does not require internal pipework for the flow of water therearound. This reduces the pressure on the pump of the main heating system that delivers hot water around a building since it no longer has to pump the water around the convoluted pipes of a conventional radiator or towel rail. The heater may be fastened to a hot water pipe or other heat source at any suitable location, thus greatly increasing the flexibility of the location of the heater and, indeed, may be provided as a stand-alone unit. Additionally, the heater will normally operate at negative pressures up to approximately 100° C. depending on the fluid in the heatpipes. Thus, the unit will only have to withstand low pressures even at high temperatures. In contrast, the radiators of the prior art always have a positive pressure that increases as the temperature of the medium in the radiator rises. Not only does this result in the heater of the present invention being safer to use but the heater may also be made of a lighter and thinner material due to the reduced pressure of the interior of the unit caused by the partial vacuum. A reduced volume of water also has to be heated and transported around the building thereby providing a far more efficient heating system. The heater may also be run off existing pipework in buildings.

FIGS. 3 and 4 of the accompanying drawings illustrate an alternative embodiment of a heater according to the present invention The heater 20 is comprised of a vertical, sealed heatpipe 40 surrounded by a cylindrical casing 42 that has a number of horizontal sealed heatpipes 44 extending therefrom. The base of the heatpipe 40 contacts a heat source 50 which transfers heat to the heatpipe and thereby heats up the horizontal heatpipes 44. The horizontal heatpipes 44 are attached to the casing 42 by means of one or more brackets 46a, 46b that are provided at intervals in the casing: The brackets are fixed in the vertical direction due to the presence of flanges 48 but are able to rotate around the central heatpipe 40 due to the presence of a slot 52 in the casing 42 (see arrow B in FIG. 4). The heatpipes 44 may be temporarily slotted into the socket formed by the branch 46b of the bracket or may be permanently welded thereto by means of a heat transfer paste. Additionally, the branch 46b of the bracket is hingedly mounted 52 to the main body 46a of the bracket to enable the horizontal pipes to be folded against the casing 42 (in the direction of arrow A shown in FIG. 4).

In this manner, the heater may be provided as a stand-alone heater having horizontal pipes 42 extending outwardly therefrom for acting as rails for supporting garments, towels and the like. The rails may be rotated about the vertical pipe and may be collapsed against the casing for easy storage when not in use. Each bracket may be provided with any number of branches extending therefrom for receiving horizontal heatpipes thereby resulting in rails extending outwardly around the circumference of the casing. Additionally, multiple brackets may be provided at spaced apart intervals to provide layers of rails up the vertical pipe.

The bracket may be dimensioned to be substantially the same size as the part that fits therein, i.e. the vertical or horizontal heatpipe. The bracket and its extension for receiving the horizontal heatpipe may be provided with a slit or cut therethrough to enable that section to be fitted over or receive the respective component part Suitable fastening means, such as Allen screws and keys, may be used across said slit or cut to clamp the components within the bracket. In one embodiment, the bracket that is fitted over the vertical heatpipe is provided with a longitudinal slit along the length thereof and the extension that receives the horizontal heatpipe is provided with two slits at right angles to the slit in the bracket (not shown). The bracket may be formed by means of a cast moulding.

Alternatively, the heater may be provided with an internal heat source, either as a stand alone unit or as part as the conventional heating system FIG. 5 of the accompanying drawings illustrates a heater according to one such embodiment of the present invention wherein the vertical pipe 100 is provided with an internal heat source 104 for heating the horizontal heatpipes 102. In this embodiment, only the horizontal heatpipes that form the rails of the heater are partially evacuated and contain a small amount of working fluid. The vertical pipe 100, for example having a diameter of 28 mm, is not evacuated and is capped at one end and open at the other. A smaller pipe 104, for example, of 15 mm in diameter, is placed up the centre of the pipe and a disc 106 is provided around the inner pipe near the base of the outer pipe and sealed to the sides of the inner and outer pipes, thereby closing off the open end of the outer pipe. The end of the inner pipe inside the outer pipe is open and the other end is in fluid communication with a standard hot water pipe (not shown). The outer pipe 100 is provided with an outlet port 108 near to the base thereof.

In this manner, hot water may be delivered up the inner pipe 104. At the top of the pipe, the water flows out into the outer pipe, thereby heating the outer pipe. The self-contained, partially evacuated heatpipes 102 that are attached by brackets 110 and extend horizontally or obliquely from the vertical pipe are then heated by means of the vertical pipe. The water then exits the vertical pipe by means of outlet 108 to be re-heated, for example by means of a conventional boiler system.

It is to be appreciated that the heatpipes maybe fixedly secured to the vertical pipe or rotabably attached thereto, as previously described in relation to FIGS. 3 and 4. Any number of heatpipes may extend from the central, vertical pipe to form rails for hanging articles.

In a further embodiment of the present invention, a heated towel rail that is interchangeable between a ladder-type towel rail and a swinging towel rail is provided, as illustrated in FIGS. 6 and 7 of the accompanying drawings. The vertical heatpipe 200 is fixedly secured to a wall bracket (not shown) attached to a wall W. A parallel metal fixing bar 208 having spaced apart retaining clips 210 is provided at a predetermined distance from the vertical heatpipe. Horizontal heatpipes 202 are rotatably mounted with respect to the vertical heatpipe by means of brackets 206. The horizontal heatpipes may be fixed in the retainers 210 on the fixing bar 208 to lie against the wall thereby acting as a ladder-type towel rail (see FIG. 6). Alternatively, one or more of the horizontal heatpipes may be pulled away from its respective retainer and rotated outwardly (as shown in FIG. 7).

1. A heater comprising a substantially vertical heatpipe in contact or fluid communication with at least one additional heatpipe that is extendable in a substantially horizontal direction therefrom, at least one of the heatpipes being at least partially evacuated and having an internal cavity for receiving a working fluid and at least one of the heatpipes being adapted to receive heat from an internal or external heat source.

2. A heater as claimed in claim 1, wherein the at least one substantially vertical heatpipe is in contact or fluid communication with a plurality of secondary heatpipes extending substantially horizontally therefrom.

3. A heater as claimed in claim 1 wherein both the vertical and horizontal heatpipes are at least partially evacuated and contain a small amount of working fluid.

4. A heater as claimed in claim 2 wherein the horizontal heatpipes extend in the same direction at spaced apart intervals to provide a series of rails for supporting articles.

5. A heater as claimed in claim 1 wherein the vertical heatpipe has a plurality of secondary heatpipes extending therefrom in different directions.

6. A heater as claimed in claim 5 wherein the vertical heatpipe is in a central position and the secondary heatpipes radiate outwardly in different directions from the primary heatpipe.

7. A heater as claimed in claim 1 wherein a heat transfer medium is transported through a conduit in contact with at least one of the heatpipes.

8. A heater as claimed in claim 2 wherein a heat transfer medium is transported through a conduit in contact with at least one of the heatpipes, and wherein the lowermost horizontal heatpipe is placed in contact with the external heat source.

9. A heater as claimed in claim 1 wherein an electric coil is wound around some or all of the heatpipes.

10. A heater as claimed in claim 1 wherein an internal heat source is provided within one or more of the heatpipes.

11. A heater as claimed in claim 10 wherein the internal heat source is an electric heating element disposed in at least one of the heatpipes.

12. A heater as claimed in claim 10 wherein the internal heat source is a heat transfer pipe extending through the interior of at least one of the heatpipes, the heat transfer pipe transporting a heat transfer medium.

13. A heater as claimed in claim 12 wherein the heat transfer pipe is open-ended within the heatpipe to deliver the heat transfer medium to the heatpipe, the heatpipe being sealed at both ends but having an outlet port to transport the heat transfer medium away from the heatpipe.

14. A heater as claimed in claim 12 wherein the heat transfer pipe extends through the vertical heatpipe.

15. A heater as claimed in claim 12 wherein the heat transfer pipe extends through the horizontal heatpipe.

16. A heater as claimed in claim 1 wherein the vertical heatpipe is enclosed within a casing.

17. A heater as claimed in claim 1 wherein one or more rotatable brackets is provided about the vertical heatpipe, each bracket having at least one extension for receiving the secondary heatpipe.

18. A heater as claimed in claim 17 wherein the secondary heatpipe is fixedly secured to the bracket.

19. A heater as claimed in claim 17 wherein the secondary heatpipe is detachable from the bracket.

20. A heater as claimed in claim 17 wherein the extension of the bracket is hinged to enable the secondary heatpipe to be folded against the primary heatpipe when not in use.

21. A heater as claimed in claim 1 wherein a buffer is provided about the heat source to prevent kettling activity.

22. A heater adapted for hanging articles comprising a vertical heatpipe having a heat source and a plurality of spaced apart heatpipes extending substantially horizontally from said vertical heatpipe, the horizontal heatpipes having an incline of +0.1 to 5° from the horizontal and being at least partially evacuated with an internal cavity for receiving a working fluid.

23. A heater as claimed in claim 22, wherein the vertical heatpipe is mountable to a surface and the horizontal heatpipes are rotatable about the vertical heatpipe, said heater further comprising retaining means for temporarily retaining the horizontal heatpipes against the surface.

24. A heater as claimed in claim 23 wherein the retaining means are provided on a member that is parallel to but spaced apart from the vertical heatpipe, the member being at a distance from the vertical heatpipe that is substantially equal to the length of the horizontal heatpipes.

25. A heater adapted for hanging articles comprising a central vertical heatpipe having a heat source and a plurality of secondary heatpipes radiating outwardly from said vertical heatpipe, said secondary heatpipes being at least partially evacuated and having an internal cavity for receiving a working fluid.

26. A heater as claimed in claim 2 wherein both the vertical and horizontal heatpipes are at least partially evacuated and contain a small amount of working fluid.

27. A heater as claimed in claim 3 wherein the horizontal heatpipes extend in the same direction at spaced apart intervals to provide a series of rails for supporting articles.

28. A heater as claimed in claim 26 wherein the horizontal heatpipes extend in the same direction at spaced apart intervals to provide a series of rails for supporting articles.

29. A heater as claimed in claim 28 wherein a heat transfer medium is transported through a conduit in contact with at least one of the heatpipes.

30. A heater as claimed in claim 29 wherein an electric coil is wound around some or all of the heatpipes.

31. A heater as claimed in claim 30 wherein an internal heat source is provided within one or more of the heatpipes.

32. A heater as claimed in claim 13 wherein the heat transfer pipe extends through the vertical heatpipe.

33. A heater as claimed in claim 13 wherein the heat transfer pipe extends through the horizontal heatpipe.

34. A heater as claimed in claim 33 wherein the vertical heatpipe is enclosed within a casing.

35. A heater as claimed in claim 34 wherein one or more rotatable brackets is provided about the vertical heatpipe, each bracket having at least one extension for receiving the secondary heatpipe.

36. A heater as claimed in claim 35 wherein the secondary heatpipe is fixedly secured to the bracket.

37. A heater as claimed in claim 35 wherein the secondary heatpipe is detachable from the bracket.

38. A heater as claimed in claim 17 wherein the extension of the bracket is hinged to enable the secondary heatpipe to be folded against the primary heatpipe when not in use.

39. A heater as claimed in claim 18 wherein the extension of the bracket is hinged to enable the secondary heatpipe to be folded against the primary heatpipe when not in use.

40. A heater as claimed in claim 19 wherein the extension of the bracket is hinged to enable the secondary heatpipe to be folded against the primary heatpipe when not in use.

41. A heater as claimed in claim 40 wherein a buffer is provided above or around the heat source to prevent kettling activity.
